(19) United States
(12) Patent Application Publication
(10) Pub. No.: US 2020/0292790 A1
(43) Pub. Date: Sep. 17, 2020

(54) OPTICAL IMAGING LENS SYSTEM

(71) Applicant: ACE SOLUTECH CO., LTD., Seongnam-si, Gyeonggi-do (KR)

(72) Inventors: Pil Sun JUNG, Gyeonggi-do (KR); Dong Young KIM, Gyeonggi-do (KR); Chi Ho AN, Gyeonggi-do (KR)

(21) Appl. No.: 16/086,223

(22) PCT Filed: Mar. 16, 2017
(86) PCT No.: PCT/KR2017/002836

§ 371 Date: Sep. 18, 2018

(30) Foreign Application Priority Data
Mar. 18, 2016 (KR) 10-2016-0032910

(51) Int. Cl. G02B 13/00; G02B 9/60

(52) U.S. Cl. CPC G02B 13/0045; G02B 9/60

(57) ABSTRACT

Provided is a lens optical system for image capturing. The lens optical system includes a first lens, a second lens, a third lens, a fourth lens, and a fifth lens that are sequentially arranged in the stated order between an object and an image sensor. The second lens and the fourth lens each have a positive (+) power, and the first lens, the third lens, and the fifth lens each have a negative (−) power

### CROSS REFERENCE TO RELATED APPLICATIONS

This application is the National Stage of International Application No. PCT/KR2017/002836, having an International Filing Date of 16 Mar. 2017, which designated the United States of America, and which International Application was published under PCT Article 21(2) as WO Publication No. 2017/160095 A1, which claims priority from and the benefit of Korean Patent Application No. 10-2016-0032910, filed on 18 Mar. 2016, the disclosures of which are incorporated herein by reference in their entireties.

### BACKGROUND

### 1. Field

The present disclosure relates to an optical apparatus, and more particularly, to a miniature lens optical system applied to an imaging apparatus.

### 2. Description of Related Art

The use of semiconductor image sensors is expanding to various fields that require image capturing, such as industrial, domestic, and recreational fields.

As the performance of semiconductor image sensors such as a charge-coupled device (CCD) and a complementary metal oxide semiconductor (CMOS) have greatly improved, these semiconductor image sensors are being widely applied to various fields. Since semiconductor image sensors are being continually innovated and their pixel density has rapidly increased, they may capture ultra-high-resolution images while being small in size.

High-quality lens optical systems corresponding to such high-pixel-density image sensors are required. High-quality optical systems, particularly super-wide-angle optical systems, may need to have small aberrations and also high sharpness in all regions.

In order to obtain high-quality images, not only such high-quality imaging devices but also corresponding lens optical systems may be required.

Recently, imaging devices, that is, image sensors, have been installed as a necessity in general compact cameras, for example, in mobile phones, and are rapidly becoming ultra-high in terms of pixel density. Accordingly, compact and high-quality lens optical systems may be required to ensure the performance of such ultra-high-pixel-density image sensors.

As such, there is still a need for research on lenses having optical performance higher than that required for compact cameras while being easy to mold and process and easy to miniaturize, and which may reduce manufacturing costs.

### SUMMARY

Provided is a subminiature ultra-slim lens optical system that is compact and may be used in an ultra-high-pixel-density imaging apparatus.

Also provided is a lens optical system that may be easily miniaturized and may reduce manufacturing costs while having high optical performance.

According to an aspect of the present disclosure, a lens optical system includes:

a lens system including a first lens, a second lens, a third lens, a fourth lens, and a fifth lens that are sequentially arranged in the stated order on an optical axis between an object and an image plane, each of the first to fifth lenses having an incidence surface facing the object and an exit surface facing the image plane,

the first lens having a negative power,

the second lens having a positive power,

the third lens having a negative power,

the fourth lens having a positive power, and

the fifth lens having a negative power,

and satisfies at least one of the following Conditions 1 to 5:

90≤FOV≤120 <Condition 1>

where FOV (Field of view) denotes an angle of view of the lens optical system in a diagonal direction.

0.6≤TTL/IH≤0.9 <Condition 2>

where TTL (Total Track Length) denotes a height from the incidence surface of the first lens to the image plane, and IH (Image Height) denotes an image height in an effective diameter.

Ld2<Ld1<Ld5 <Condition 3>

where Ld1, Ld2, and Ld5 denote an effective diameter of the first lens, an effective diameter of the second lens, and an effective diameter of the fifth lens, respectively.

0.7<Ind2/Ind3<1.5 <Condition 4>

where Ind2 and Ind3 denote a refractive index of the second lens and a refractive index of the third lens, respectively.

1.5≤abv2/abv3≤1.5 <Condition 5>

where abv2 and abv3 denote an Abbe number of the second lens and an Abbe number of the third lens, respectively.

According to an embodiment of the present disclosure, an aperture diaphragm (stop) may be provided between the first lens and the second lens in the lens optical system.

According to an embodiment of the present disclosure, at least one of the first to fifth lenses may have an aspherical incidence surface or exit surface. Also, the fifth lens may have at least two inflection points.

It may be possible to implement a wide-angle lens optical system that is compact and may achieve high performance/high resolution. More particularly, a lens optical system according to an embodiment of the present disclosure may include a first lens, a second lens, a third lens, a fourth lens, and a fifth lens that are sequentially arranged in the stated order from an object to an image sensor and have a negative (−) power, a positive (+) power, a negative (−) power, a positive (+) power, and a negative (−) power respectively, and may include an aperture diaphragm arranged between the first lens and the second lens or may satisfy at least one of the Conditions 1 to 5. As a wide-angle optical apparatus, the lens optical system may be suitable for a subminiature security camera, an action camera, and the like as well as a general photographing apparatus.

### BRIEF DESCRIPTION OF DRAWINGS

FIG. 1 is a cross-sectional view illustrating the arrangement of main components of a lens optical system according to a first embodiment of the present disclosure.

FIG. 2 is a cross-sectional view illustrating the arrangement of main components of a lens optical system according to a second embodiment of the present disclosure.

FIG. 3 is a cross-sectional view illustrating the arrangement of main components of a lens optical system according to a third embodiment of the present disclosure.

FIG. 4 is an aberration diagram illustrating longitudinal spherical aberration, astigmatic field curvature, and distortion of the lens optical system according to the first embodiment of the present disclosure.

FIG. 5 is an aberration diagram illustrating longitudinal spherical aberration, astigmatic field curvature, and distortion of the lens optical system according to the second embodiment of the present disclosure.

FIG. 6 is an aberration diagram illustrating longitudinal spherical aberration, astigmatic field curvature, and distortion of the lens optical system according to the third embodiment of the present disclosure.

### DETAILED DESCRIPTION

Hereinafter, lens optical systems according to embodiments of the present disclosure will be described in detail with reference to the accompanying drawings Like reference numerals will denote like elements throughout the specification.

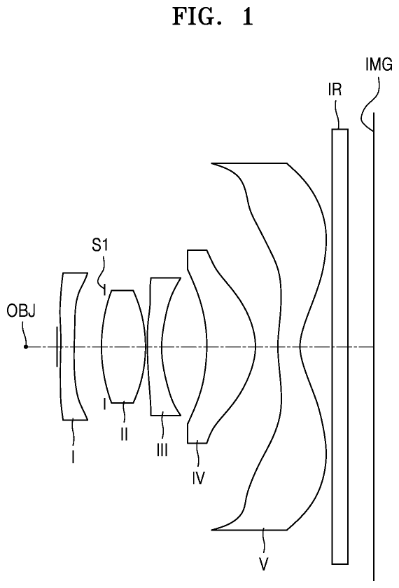

FIGS. 1 to 3 illustrate lens optical systems according to first to third embodiments of the present disclosure, respectively.

As illustrated in FIGS. 1 to 3, the lens optical system according to embodiments of the present disclosure may include five groups of five lenses and may include five lenses that are sequentially arranged from a subject or an object OBJ to an image plane or an image sensor IMG where an image of the object OBJ is formed.

As described below, and incidence surface may refer to a surface facing an object and an exit surface may refer to a surface facing an image sensor.

The five lenses may have an incidence surface where light is incident, that is, an incidence surface facing the object OBJ, and an exit surface where light exits, that is, an exit surface facing the image sensor IMG, and may include a first lens I, a second lens II, a third lens III, a fourth lens IV, and a fifth lens V.

The first lens I may have a negative (−) power and may have an aspherical surface according to an embodiment of the present disclosure. The central portions of both surfaces of the first lens I of the present disclosure may all be convex toward the image plane or the object.

The second lens II may have a positive (+) power, may have an incidence surface having an aspherical surface convex toward the object according to an embodiment of the present disclosure, and may be a biconvex lens.

The third lens III may have a negative (−) power and may have an aspherical surface according to an embodiment of the present disclosure. At least one of the incidence surface and the exit surface of the third lens III may be convex toward the object OBJ.

The fourth lens IV may have a positive (+) power and may be an aspherical lens having an exit surface convex toward the image plane according to an embodiment of the present disclosure. Also, the fourth lens IV may be a meniscus lens having an exit surface convex toward the image plane.

The fifth lens V may have a negative (−) power, and according to an embodiment of the present disclosure, at least one of an incidence surface and an exit surface thereof may be an aspherical surface and the aspherical surface may have at least two inflection points.

An aperture diaphragm (stop) S1 and an infrared blocking unit IR may be further provided in the lens optical system of the present disclosure. The aperture diaphragm S1 may be provided between the first lens I and the second lens II. The infrared blocking unit IR may be provided between the fifth lens V and the image sensor IMG.

The infrared blocking unit IR may be an infrared blocking filter. The positions of the aperture diaphragm 51 and the infrared blocking unit IR may vary according to various embodiments.

The lens optical system having the above configuration according to embodiments of the present disclosure may satisfy at least one of the following Conditions 1 to 5.

90≤FOV≤120 <Condition 1>

Here, FOV (Field of view) denotes an angle of view of the optical system in a diagonal direction. This is a condition for constructing a wide-angle lens.

0.6≤TTL/IH≤0.9 <Condition 2>

Here, TTL (Total Track Length) denotes a height from the incidence surface of the first lens to the image plane and IH (Image Height) denotes an image height in an effective diameter.

This defines the total length of the optical lens system with respect to the sensor size, which is a condition for designing an ultra-slim structure that may be mounted on a mobile phone while being a wide-angle lens.

Ld2<Ld1<Ld5 <Condition 3>

Here, Ld1, Ld2, and Ld5 denote an effective diameter of the first lens, an effective diameter of the second lens, and an effective diameter of the fifth lens respectively.

This is a design condition for implementing high performance while implementing a wide-angle optical system. As illustrated in FIGS. 1 to 3, the aperture of the second lens II may be the smallest and the first lens I may be larger than the second lens II and may have a smaller aperture than the fifth lens V.

0.7≤Ind2/Ind3≤1.5 <Condition 4>

Here, Ind2 and Ind3 denote a refractive index of the second lens and a refractive index of the third lens respectively.

This is a design condition for minimizing chromatic aberration.

1.5≤abv2/abv3≤1.5 <Condition 5>

Here, abv2 and abv3 denote an Abbe number of the second lens and an Abbe number of the third lens respectively.

As such, since the second lens II has a high Abbe number and the third lens III has a relatively low Abbe number, the chromatic aberration may be minimized.

Meanwhile, in the lens optical system according to an embodiment of the present disclosure, an aperture diaphragm (stop) may be provided between the first lens and the second lens, and the position thereof may vary according to other embodiments.

According to a particular embodiment of the present disclosure, at least one of the first to fifth lenses may have an aspherical incidence surface or exit surface. Also, at least one of the incidence surface and the exit surface of the fifth lens may have at least two inflection points.

Table 1 below shows the optical characteristics of the first to third embodiments EMB1 to EMB3 illustrated in FIGS. 1 to 3.

TABLE 1

| Definition | EMB1 | EMB2 | EMB3 |
|---|---|---|---|
| Image Height (IH) | 6.12 | 6.09 | 6.09 |
| Total Track Length (TTL) | 4.15 | 3.95 | 3.95 |
| Overall Length (OVL) | 3.18 | 3.35 | 3.29 |
| Field of View (FOV) | 99.61 | 98.03 | 98.24 |
| Effective Focal Length (EFL) | 2.54 | 2.68 | 2.65 |
| Back Focal Length (BFL) | 0.97 | 0.60 | 0.66 |
| F Number (EFL/EPD) | 1.98 | 2.29 | 2.28 |
| Effective Diameter of | 1.920 | 1.701 | 1.735 |
| First Lens (LD1) | | | |
| Effective Diameter of | 1.466 | 1.400 | 1.400 |
| Second Lens (LD2) | | | |
| Effective Diameter of | 4.793 | 4.968 | 4.783 |
| Fifth Lens (LD5) | | | |
| Refractive Index of | 1.544 | 1.544 | 1.544 |
| Second Lens (Ind2) | | | |
| Refractive Index of | 1.650 | 1.650 | 1.650 |
| Third Lens (Ind3) | | | |
| Abbe Number of | 56.093 | 56.093 | 56.093 |
| Second Lens (abv2) | | | |
| Abbe Number of | 21.474 | 21.474 | 21.474 |
| Third Lens (abv3) | | | |

Herein, IH denotes an image height of an effective diameter and TTL denotes a distance from the center of the incidence surface of the first lens I to the sensor. Also, OAL denotes a distance or height from the center of the incidence surface of the first lens I to the center of the exit surface of the fifth lens as described above, the unit of which is mm. Also, FOV denotes an angle of view (degree) of the optical system in the diagonal direction.

Table 2 below shows the results of comparing the optical conditions of the first to third embodiments of the present disclosure to the above Conditions 1 to 5.

TABLE 2

| Condition | Definition | EMB1 | EMB2 | EMB3 |
|---|---|---|---|---|
| 1 | 90 ≤ FOV ≤ 120 | 99.61 | 98.03 | 98.24 |
| 2 | 0.6 ≤ TTL/IH ≤ 0.9 | 0.68 | 0.65 | 0.65 |
| 3 | Ld2 ≤ Ld1 ≤ Ld5 | Refer | Refer | Refer |
| | | Drawing | Drawing | Drawing |
| 4 | 0.7 ≤ Ind2/Ind3 ≤ 1.5 | 0.94 | 0.94 | 0.94 |
| 5 | 1.5 ≤ Abv2/Abv3 ≤ 3.0 | 2.61 | 2.61 | 2.61 |

Referring to Table 2, it may be seen that the lens optical systems of the first to third embodiments satisfy the Conditions 1 to 5. In the lens optical system having this configuration according to embodiments of the present disclosure, the first to fifth lenses I to V may be made of plastic in consideration of the shapes and dimensions thereof and particularly the first lens having a large diameter may be made of plastic having a high refractive index.

Hereinafter, the first to third embodiments of the present disclosure will be described in detail with reference to the lens data and the accompanying drawings.

Tables 3 to 5 below show the curvature radius, the lens thickness or the distance between lenses, the refractive index, and the Abbe number of each lens constituting the lens optical systems of FIGS. 1 to 3, respectively.

In Tables 3 to 5, R denotes a curvature radius, D denotes a lens thickness or a lens interval or an interval between adjacent components, Nd denotes a refractive index of a lens measured by using a d-line, and Vd denotes an Abbe number of the lens with respect to the d-line. Herein, the unit of “R” value and “D” value is mm.

TABLE 3

| EMB1 | Surface | Radius | Thickness | Nd | Vd |
|---|---|---|---|---|---|
| I | 1 | −5.91216 | 0.18000 | 1.54410 | 56.09278 |
| | 2 | −22.54527 | 0.40000 | | |
| | Stop | Infinity | −0.03747 | | |
| II | 4 | 2.02210 | 0.57491 | 1.54410 | 56.09278 |
| | 5 | −1.85016 | 0.03000 | | |
| III | 6 | 3.67991 | 0.19480 | 1.65041 | 21.47439 |
| | 7 | 1.51577 | 0.59046 | | |
| IV | 8 | −2.16515 | 0.64597 | 1.54410 | 56.09278 |
| | 9 | −0.83239 | 0.29744 | | |
| V | 10 | 1.85884 | 0.30000 | 1.54410 | 56.09278 |
| | 11 | 0.67685 | 0.42002 | | |

TABLE 4

| EMB2 | Surface | Radius | Thickness | Nd | Vd |
|---|---|---|---|---|---|
| I | 1 | 28.14467 | 0.20000 | 1.53175 | 55.85588 |
| | 2 | 6.14204 | 0.39508 | | |
| | Stop | Infinity | −0.06000 | | |
| II | 4 | 1.86396 | 0.49574 | 1.54410 | 56.09278 |
| | 5 | −2.05351 | 0.02604 | | |
| III | 6 | 3.64468 | 0.21470 | 1.65041 | 21.47439 |
| | 7 | 1.53177 | 0.55231 | | |
| IV | 8 | −4.43951 | 0.50551 | 1.54410 | 56.09278 |
| | 9 | −1.43085 | 0.71659 | | |
| V | 10 | 2.53440 | 0.30000 | 1.54410 | 56.09278 |
| | 11 | 0.85417 | 0.30000 | | |

TABLE 5

| EMB3 | Surface | Radius | Thickness | Nd | Vd |
|---|---|---|---|---|---|
| I | 1 | −15.75621 | 0.20000 | 1.53175 | 55.85588 |
| | 2 | 10.22247 | 0.24000 | | |
| | Stop | Infinity | −0.02542 | | |
| II | 4 | 2.01672 | 0.59967 | 1.54410 | 56.09278 |
| | 5 | −1.89260 | 0.02500 | | |
| III | 6 | 3.88767 | 0.20000 | 1.65041 | 21.47439 |
| | 7 | 1.60023 | 0.41621 | | |
| IV | 8 | −5.15312 | 0.51888 | 1.54410 | 56.09278 |
| | 9 | −1.56428 | 0.80389 | | |
| V | 10 | 1.60697 | 0.31000 | 1.54410 | 56.09278 |
| | 11 | 0.75421 | 0.35000 | | |

Meanwhile, in the lens optical systems according to the first to third embodiments of the present disclosure, all or some of the lenses may have aspherical surfaces. In the lens optical systems according to the first to third embodiments of the present disclosure, the aspherical surfaces may satisfy the following aspherical equation.

$$Z = \frac{{Y}^{2}}{R ( 1 + \sqrt{1 - ( 1 + K ) {Y}^{2} \text{/} {R}^{2}}} + {AY}^{4} + {BY}^{6} + {CY}^{8} + {DY}^{10} + {EY}^{12} + {FY}^{14} + {GY}^{16} + {HY}^{18} + {JY}^{20}$$

Here, “Z” denotes a distance from the vertex of each lens in the optical axis direction, “Y” denotes a distance in a direction perpendicular to the optical axis, “R” denotes a curvature radius in the vertex of the lens, “K” denotes a conic constant, and “A, B, C, D, E, F, G, H, and J” denote aspherical coefficients.

Tables 6 to 8 below show aspherical coefficients in the lens systems according to the first to third embodiments corresponding to FIGS. 1 to 3, respectively. In Tables below, the aspherical coefficients H and J are excluded, which means zero (0) on all lens surfaces.

TABLE 6

| EMB1 | S | K | A | B | C | D | E | F | G |
|---|---|---|---|---|---|---|---|---|---|
| | 1 | −74.76371 | 0.19920 | −0.19970 | 0.52793 | −1.30930 | 1.70084 | −1.10721 | 0.28287 |
| | 2 | 0.00000 | 0.37305 | −0.44908 | 1.88867 | −5.35558 | 7.92598 | −5.61393 | 1.43185 |
| | 4 | 5.15410 | −0.03424 | 0.32901 | −4.55811 | 20.33717 | −52.04412 | 69.24584 | −38.93880 |
| | 5 | −5.64093 | 0.02469 | −0.41624 | −0.22208 | 4.34826 | −12.41074 | 15.24882 | −7.53457 |
| | 6 | 0.00000 | −0.08173 | −0.42786 | 1.28414 | −1.76714 | 1.04168 | 0.25867 | −0.38442 |
| | 7 | 0.96668 | −0.26656 | 0.32624 | −0.84417 | 2.31563 | −4.09204 | 3.95542 | −1.55769 |
| | 8 | 2.14874 | −0.04813 | 0.62700 | −2.91338 | 6.83751 | −8.46334 | 5.52511 | −1.51310 |
| | 9 | −0.89611 | 0.28559 | −0.64423 | 1.35655 | −2.07073 | 1.91047 | −0.87211 | 0.15056 |
| | 10 | −23.26696 | −0.20861 | 0.07389 | −0.01377 | 0.00199 | −0.00016 | 0.00000 | 0.00000 |
| | 11 | −4.22012 | −0.14725 | 0.07957 | −0.03001 | 0.00666 | −0.00079 | 0.00004 | 0.00000 |

TABLE 7

| EMB2 | S | K | A | B | C | D | E | F | G |
|---|---|---|---|---|---|---|---|---|---|
| I | 1 | 0.00000 | 0.03130 | −0.08861 | 0.72629 | −2.15199 | 3.20588 | −2.44768 | 0.74642 |
| | 2 | 0.00000 | 0.09187 | 0.04612 | 0.71759 | −3.60881 | 8.07350 | −8.64563 | 3.42595 |
| II | 4 | 4.27905 | −0.10832 | 0.29057 | −3.79594 | 18.75994 | −56.17234 | 87.77948 | −58.97857 |
| | 5 | −5.18996 | −0.07238 | 0.29200 | −1.38937 | 1.36494 | 0.85362 | −2.83904 | 0.15055 |
| III | 6 | 0.00000 | −0.19403 | 0.85394 | −2.84682 | 5.56839 | −7.00136 | 4.89386 | −1.37784 |
| | 7 | 0.78593 | −0.27108 | 0.57646 | −1.00982 | 0.89222 | −0.22880 | −0.19331 | 0.09648 |
| IV | 8 | 19.64703 | −0.04891 | 0.09002 | −0.59829 | 1.66709 | −1.98944 | 1.20741 | −0.31084 |
| | 9 | −0.22846 | −0.00330 | −0.08513 | 0.43623 | −1.04125 | 1.35494 | −0.78761 | 0.16442 |
| V | 10 | −75.58044 | −0.49261 | 0.27661 | −0.06815 | 0.00828 | −0.00041 | 0.00000 | 0.00000 |
| | 11 | −6.05496 | −0.18855 | 0.12543 | −0.05818 | 0.01684 | −0.00298 | 0.00030 | −0.00001 |

TABLE 8

| EMB3 | S | K | A | B | C | D | E | F | G |
|---|---|---|---|---|---|---|---|---|---|
| I | 1 | 0.00000 | 0.10995 | −0.05667 | 0.38318 | −1.19917 | 1.83258 | −1.41384 | 0.41899 |
| | 2 | 0.00000 | 0.23621 | −0.31836 | 2.87949 | −11.29068 | 24.11055 | −25.81581 | 10.52428 |
| II | 4 | 4.47003 | −0.09146 | 0.14975 | −2.27974 | 9.50760 | −25.69914 | 37.92166 | −26.13353 |
| | 5 | −3.17391 | −0.09919 | 0.27512 | −2.12639 | 6.21943 | −12.88683 | 16.27560 | −9.68048 |
| III | 6 | 0.00000 | −0.18718 | 0.70701 | −2.21747 | 3.85204 | −3.78367 | 1.87603 | −0.33575 |
| | 7 | 0.98136 | −0.25196 | 0.52272 | −0.96000 | 1.04324 | −0.64573 | 0.24019 | −0.06076 |
| IV | 8 | 24.09359 | −0.01630 | 0.14816 | −0.57871 | 1.63122 | −2.03845 | 1.24101 | −0.31084 |
| | 9 | −0.40043 | −0.00519 | 0.00096 | 0.21863 | −0.59268 | 0.88733 | −0.57028 | 0.12746 |
| V | 10 | −20.70602 | −0.40296 | 0.17140 | −0.03809 | 0.00726 | −0.00087 | 0.00000 | 0.00000 |
| | 11 | −4.64310 | −0.18784 | 0.12451 | −0.05679 | 0.01666 | −0.00304 | 0.00031 | −0.00001 |

As described above, the lens optical system according to the present disclosure may have a lens configuration of five groups of five lenses, a positive (+) power may be given to the second lens and the fourth lens, and a negative (−) power may be given to the first lens, the third lens, and the fifth lens. In this optical arrangement, all the lenses may have an aspherical incidence surface or exit surface. Also, the aspherical surface of the fifth lens may have at least two inflection points.

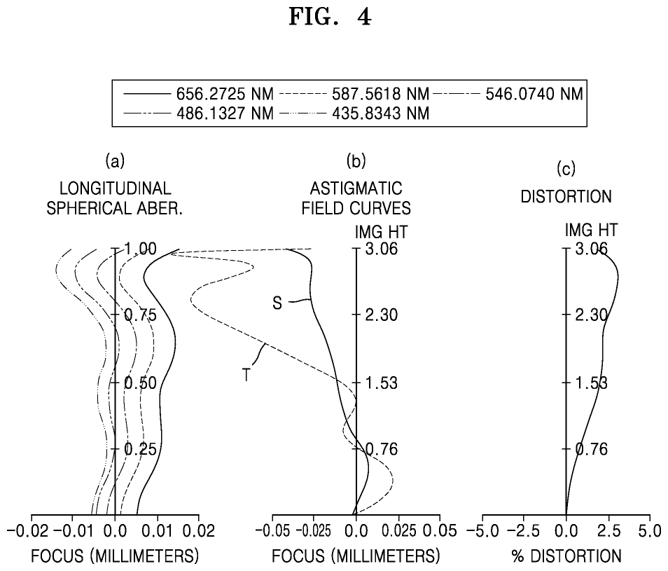

FIG. 4 is an aberration diagram illustrating longitudinal spherical aberration, astigmatic field curvature, and distortion of the lens optical system according to the first embodiment (FIG. 1) of the present disclosure, that is, the lens optical system having the numerical values of Table 3.

FIG. 4(a) illustrates spherical aberration of the lens optical system with respect to various wavelengths of light, and FIG. 4(b) illustrates astigmatic field curvature (i.e., tangential field curvature T and sagittal field curvature S) of the lens optical system.

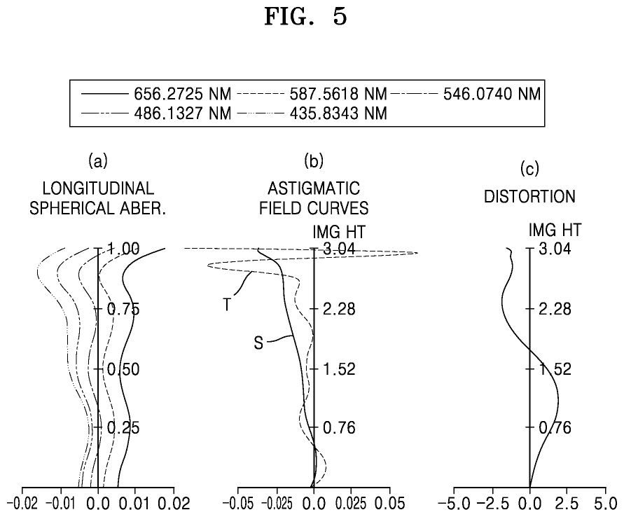

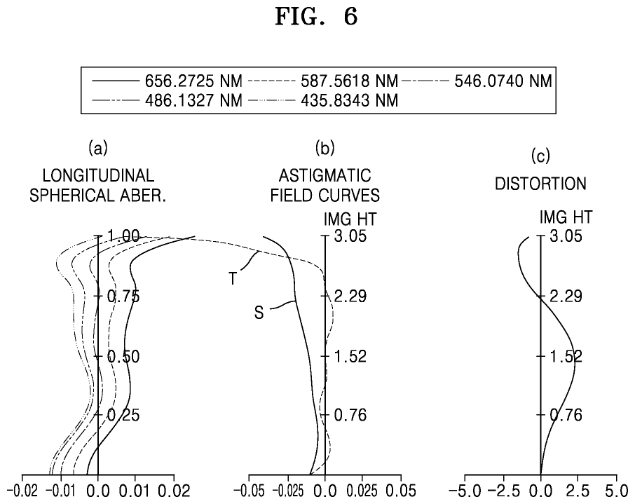

Herein, light wavelengths 656.2725 nm, 587.5618 nm, 546.0740 nm, 486.1327 nm, and 435.8343 nm are used to obtain (a) data. A light wavelength 546.0740 nm is used to obtain (b) and (c) data. This is also true in FIGS. 5 and 6.

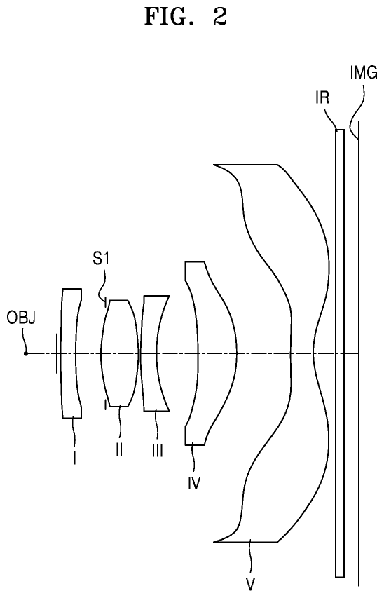

FIG. 5(a), FIG. 5(b), and FIG. 5(c) are respectively aberration diagrams illustrating longitudinal spherical aberration, astigmatic field curvature, and distortion of the lens optical system according to the second embodiment (FIG. 2) of the present disclosure, that is, the lens optical system having the numerical values of Table 4.

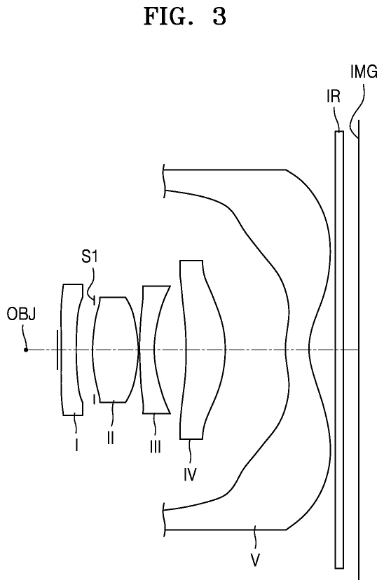

FIG. 6(a), FIG. 6(b), and FIG. 6(c) are respectively aberration diagrams illustrating longitudinal spherical aberration, astigmatic field curvature, and distortion of the lens optical system according to the third embodiment (FIG. 3) of the present disclosure, that is, the lens optical system having the numerical values of Table 5.

As described above, a lens optical system according to embodiments of the present disclosure may include first to fifth lenses I to V that are sequentially arranged from an object OBJ to an image sensor IMG and have a negative (−) power, a positive (+) power, a negative (−) power, a positive (+) power, and a negative (−) power respectively, and may satisfy at least one of the above Conditions 1 to 5. The lens optical system may easily (well) correct various aberrations and may have a relatively short total length. Thus, according to an embodiment of the present disclosure, it may be possible to implement a lens optical system that is suitable particularly for a mobile phone and may obtain high performance and high resolution while being small in size.

All of the first to fifth lenses I to V may be plastic lenses. In the case of glass lenses, it may be difficult to miniaturize the lens optical system due to the constraint conditions of molding/processing as well as high manufacturing cost. However, in the present disclosure, since all of the first to fifth lenses I to V may be made of plastic, various advantages may be achieved accordingly.

However, in the present disclosure, the material of the first to fifth lenses I to V is not limited to plastic. When necessary, at least one of the first to fifth lenses I to V may be made of glass.

As described above, the fifth lens may have a negative (−) power and may have an aspherical surface having at least two inflection points.

According to the present disclosure, since all the lenses may be made of plastic, a lens optical system that is compact and has excellent performance may be implemented at low cost in comparison with the case of using glass lenses.

According to the present disclosure, even in the case of high-performance lenses incorporated in a mobile phone, a subminiature and ultra-slim lens optical system may be implemented. Particularly, a plastic aspherical material may be used for an ultra-slim optical system applied to a mobile phone, and it may be possible to achieve a design having low sensitivity while implementing high performance by power arrangement distribution according to suitable diaphragm position setting, and thus, mass production may be ensured. The lens optical systems according to the present disclosure may be applied to various fields such as security cameras and action cameras as well as cameras.

Although many details have been described above, they are not intended to limit the scope of the present disclosure, but should be interpreted as examples of the embodiments. For example, those of ordinary skill in the art will understand that various additional elements may be used as the infrared blocking means IR in addition to the filter. It will also be understood that various other modifications are possible. Therefore, the scope of the present disclosure should be defined not by the described embodiments but by the technical spirit and scope described in the following claims.

What is claimed is:

1. A lens optical system comprising:
a lens system comprising a first lens, a second lens, a third lens, a fourth lens, and a fifth lens that are sequentially arranged in the stated order on an optical axis between an object and an image plane, each of the first to fifth lenses having an incidence surface facing the object and an exit surface facing the image plane, the first lens having a negative power, the second lens having a positive power, the third lens having a negative power, the fourth lens having a positive power, and the fifth lens having a negative power,
wherein the lens optical system satisfies the following Condition 1:
90≤FOV≤120 <Condition 1>
where FOV (Field of view) denotes an angle of view of the lens optical system in a diagonal direction.

2. The lens optical system of claim 1, wherein the lens optical system further satisfies the following Condition 2:
0.6≤TTL/IH≤0.9 <Condition 2>
where TTL (Total Track Length) denotes a height from the incidence surface of the first lens to the image plane, and IH (Image Height) denotes an image height in an effective diameter.

3. The lens optical system of claim 1, wherein the lens optical system further satisfies the following Condition 3:
Ld2<Ld1<Ld5 <Condition 3>
where Ld1, Ld2, and Ld5 denote an effective diameter of the first lens, an effective diameter of the second lens, and an effective diameter of the fifth lens, respectively.

4. The lens optical system of claim 1, wherein the lens optical system further satisfies the following Condition 4:
0.7≤Ind2/Ind3≤1.5 <Condition 4>
where Ind2 and Ind3 denote a refractive index of the second lens and a refractive index of the third lens, respectively.

5. The lens optical system of claim 4, wherein the lens optical system further satisfies the following Condition 5:
1.5≤abv2/abv3≤1.5 <Condition 5>
where abv2 and abv3 denote an Abbe number of the second lens and an Abbe number of the third lens, respectively.

6. The lens optical system of claim 1, wherein the lens optical system further satisfies the following Condition 5:
1.5≤abv2/abv3≤1.5 <Condition 5>
where abv2 and abv3 denote an Abbe number of the second lens and an Abbe number of the third lens, respectively.

7. The lens optical system of claim 1, wherein an aperture diaphragm (stop) is provided between the first lens and the second lens.

8. A lens optical system comprising:
a lens system comprising a first lens, a second lens, a third lens, a fourth lens, and a fifth lens that are sequentially arranged in the stated order on an optical axis between an object and an image plane, each of the first to fifth lenses having an incidence surface facing the object and an exit surface facing the image plane, the first lens having a negative power, the second lens having a positive power and the incidence surface of the second lens being convex toward the object, the third lens having a negative power, the fourth lens having a positive power and the exit surface of the fourth lens being convex toward the image plane, and the fifth lens having a negative power,
wherein the lens optical system satisfies at least one of the following Conditions 1 to 5:
70≤FOV≤90 <Condition 1>
where FOV (Field of view) denotes an angle of view of the lens optical system in a diagonal direction.
0.6≤TTL/IH≤0.9 <Condition 2>
where TTL (Total Track Length) denotes a height from the incidence surface of the first lens to the image plane, and IH (Image Height) denotes an image height in an effective diameter.
Ld2<Ld1<Ld5 <Condition 3>
where Ld1, Ld2, and Ld5 denote an effective diameter of the first lens, an effective diameter of the second lens, and an effective diameter of the fifth lens, respectively.
0.7≤Ind2/Ind3≤1.5 <Condition 4>
where Ind2 and Ind3 denote a refractive index of the second lens and a refractive index of the third lens, respectively.
1.5≤abv2/abv3≤1.5 <Condition 5>
where abv2 and abv3 denote an Abbe number of the second lens and an Abbe number of the third lens, respectively.

9. The lens optical system of claim 8, wherein at least one of the incidence surface and the exit surface of the fifth lens is an aspherical surface having at least two inflection points.

10. The lens optical system of claim 8, wherein an aperture diaphragm is provided between the first lens and the second lens.
